(19) United States
(12) Patent Application Publication
(10) Pub. No.: US 2014/0284206 A1
(43) Pub. Date: Sep. 25, 2014

(54) METHOD FOR CONVERTING METHANOL

(71) Applicant: DALIAN UNIVERSITY OF TECHNOLOGY, Dalian, Liaoning (CN)

(72) Inventors: Hongchen Guo, Dalian (CN); Jing Zhang, Dalian (CN); Qichao Yuan, Dalian (CN)

(21) Appl. No.: 14/354,911

(22) PCT Filed: Dec. 29, 2011
(86) PCT No.: PCT/CN2011/084954

§ 371 Date: Apr. 28, 2014

(30) Foreign Application Priority Data
Oct. 27, 2011 (CN) 20110331979.7
Oct. 27, 2011 (CN) 201110332089.8
Oct. 27, 2011 (CN) 201110332201.8
Oct. 27, 2011 (CN) 201110332485.0

(51) Int. Cl. B01J 19/08

(52) U.S. Cl. CPC B01J 19/088
USPC 204/168

(57) ABSTRACT

The invention belongs to the field of plasma chemistry technology, and it involves a method of methanol conversion. Some electric discharge methods, such as dielectric barrier discharge (DBD), corona discharge, pulse corona discharge, glow discharge, etc. were used to selectively excite methanol molecule. The reactant residence time, temperature, pressure and carrier gas/methanol mole proportion were regulated to convert methanol to the objective products. The present invention mainly used methanol as raw material to synthesis ethylene glycol (EG). This method is a one-step synthesis technology, non-catalyst, environmental pollution-free and high selectivity to the EG. Moreover, methanol was a sustainable resource which can be obtained by many approaches. In this invention, ethanol, n-propanol were also obtained together with EG by the optimizing of reaction conditions, so this technology has great industrial prospects.

### TECHNICAL FIELDS

The present invention belongs to the field of synthesis chemicals by plasma technology. It relates to a method for converting methanol to ethylene glycol using plasma discharge technology.

### BACKGROUND ART

Methanol is an important raw material for chemical industry, it has been widely applied in various fields, such as synthesis of dimethyl ether, olefin, hydrogen, gasoline, carbonate, aromatic hydrocarbon, ethanol, ethylene glycol, acetic acid and fuels. Since the coal resources are abundant in the world, the industry of coal-to-methanol is developed more and more rapidly. Hence, to making various high valuable chemical products from methanol has an extensive application prospects.

There are so many literatures and patents related to the conversion of methanol, and the patents which convert methanol to olefins are listed as follows: CN101250080A; CN101279280A; CN101270020A; CN101327446A; CN101328101A; US20030621788; US20050075286; US20050211880; US20060503913; US20060540802; CA20072664404; US2009005624A1; US20080260751;

Many patents related to the method of converting methanol to dimethyl ether, which is also the hot spot issue of methanol research field, such as: CN1125216A; CN1301686A; CN1368493A; CN1180064A; CN101119952A; CN101104575A; CN101659600A; US20020188882; US20050241321; WO2006CN01965; US20070310529; WO2008090268A1; US20080594006; US20080663058; US20080188882; WO2009126765A2

Furthermore, there are some patents related to converting methanol to hydrogen, gasoline, aromatic hydrocarbon, carbonic ester, fuels and so on, such as: CN101104813A; CN201024087; CN201068444; CN101343574A; CN101381287A; JP20030346324; US20040476510; EP20040746362; WO2005JP20699; EP20050805952; US20060988799; US2007207361A1; US20070955610

There are also many literatures related to converting methanol to olefin, aromatic hydrocarbon, fuel, diethyl ether and so on. In addition, there are some patents related to converting methanol to ethanol, propanol, and ethylene glycol, such as:

U.S. Pat. No. 3,248,432A (application number US19610158870, application date 1961 Dec. 12) released a method of converting methanol to ethanol. The technology characteristics of which can be described as: methanol, CO, and H₂ are reacted to synthesize ethanol at the presence of water soluble Co/catalyst, iodine accelerant and phosphide/methanol solution. Reaction temperature: 150-250° C., reaction pressure 20.7-103.5 MPa.

U.S. Pat. No. 4,424,383A (application number US19810320008, application date 1981 Nov. 10) released a method of converting methanol to ethanol and n-propanol. The technology characteristics of which can be described as: methanol, CO and H₂ are reacted to synthesis ethanol and n-propanol at the presence of Co—Ru—I-Organophosphorus/catalyst. Reaction temperature: 150˜250° C., reaction pressure: 20˜60 MPa.

U.S. Pat. No. 4,337,371A (application number US19800183537, application date 1980 Sep. 2) released a method of converting methanol and methyl aldehyde to ethylene glycol. The technology characteristics of which can be described as: by using organic peroxides of wt %<6% like DTBP or DCP as initiator to get the product of ethylene glycol content as high as 7.71%.

Patent JP63027445A (application number 19860168874, application date 1986 Jul. 17) released a method of converting methanol to ethylene glycol. The technology characteristics of which can be described as: first dehydrating methanol to get dimethyl ether. Then oxidative coupling of dimethyl ether to synthesis dimethoxyethane at the presence of catalyst. At last, dimethoxyethane hydrolyzes to ethylene glycol.

U.S. Pat. No. 5,214,182 (application number 726715, application date 1991 Jun. 1) released a method of producing ethylene glycol. The technology characteristics of which can be described as: at the presence of heterogeneous polymerization catalyst of phosphine, methanol and ethylene carbonate react to produce ethylene glycol, and co-produce DMC at the same time. The total selectivity of ethylene glycol and DMC reach up to 98%.

In addition, there are some patents which related the method of converting methanol to ethanol, n-propanol and ethylene glycol:

U.S. Pat. No. 4,277,634A; U.S. Pat. No. 4,239,924; U.S. Pat. No. 4,235,801A; U.S. Pat. No. 4,355,192A; JP57122028A; US19810224199; U.S. Pat. No. 4,472,522A; U.S. Pat. No. 4,472,526A; US19810223514; JP19810206294; US20080228572; EP2244993; EP20080800368; WO2008CA01676; U.S. Pat. No. 4,013,700;

In addition, there are some literatures which related the method of converting methanol to ethylene glycol:

Literature: Chinese Journal of Catalysis VOL. 19, No. 6, 1998, 601-604. reported a method of converting methanol to ethylene glycol. The feature is that: using nano-ZnS as catalyst, methanol solution is used to synthesis ethylene glycol under the exposing of mercury lamp. The selectivity of ethylene glycol is influenced by optical source, catalyst temperature, reaction time, pH of solution and so on. The maximum selectivity can reach more than 90%.

Literature: Chinese Journal of Chemical Physics VOL. 16, No. 7, 2000, 601-607. Reported a method of oxidative coupling of methanol to ethylene glycol. The feature is that: preparing solid surface materials of Li₃PO₄, BiPO₄ and Li₃PO₄.BiPO₄ and activating their oxygen by using laser photon on 1077 cm⁻¹ frequency to motivate bond P═O on solid surface. The activative oxygen dehydrogenates the methanol molecule to produce ethylene glycol. The conversion of methanol reaches up to 16% and the selectivity of ethylene glycol reaches up to 97.7% when motivating the surface of Li₃PO₄.BiPO₄ 1000 times by using laser on 1077 cm⁻¹ frequency in normal pressure and 120° C.

Literature: J. Photochem. Photobiol. A: Chem, 74, 1993, 85-89. reported a method of converting methanol to hydrogen and ethylene glycol. The feature is that: at the presence of ZnS colloid, methanol solution converts to ethylene glycol and hydrogen directly after irradiated by UV-light. The yield of ethylene glycol and hydrogen and the selectivity of ethylene glycol are closely related to initial pH and reaction temperature. The selectivity of ethylene glycol reaches up to 95%. The yield of ethylene glycol is between 6.5 mmol to 44.8 mmol in reaction of 6 h. The experiment shows that: .H₂OH is the main free radical intermediate in alkaline reaction and its coupling is the main way to form ethylene glycol.

The plasma technology is not involved in the literatures and patents about converting methanol to ethylene glycol above. Here are some patents and literatures about methanol conversion by plasma discharge.

Literature: The Second International & Youth Hydrogen Forum, 2003, 77-81. Reported a method of converting methanol to hydrogen in cold plasma. The feature is: the hydrogen production can be up to 50 ml/min and the energy efficiency reaches 1.5 mmol/kJ when methanolysis in corona discharge reactor under atmospheric pressure. The conversion of methanol reaches up to 80%. The product includes a few carbon monoxide and trace amount of ethanol, n-propanol, ethylene glycol.

Literature: Journal of Chemical Engineering, VOL. 55, No. 12, 2004, 1989-1993. Reported a method of converting methanol to hydrogen in corona discharge plasma. The feature is that: to investigate the effect of DC and AC corona discharge in methanol conversion separately. It's quite useful to convert methanol in AC sine-wave and triangle sine-wave, that the conversion of methanol can be up to 70% and the rate of hydrogen production reaches 50 ml·min⁻¹. At the same time, in the journal, it points that there is trace amount of ethylene glycol in the product.

Literature: IEEE TRANSACTIONS ON INDUSTRY APPLICATIONS, VOL. 39, NO. 2, MARCH/APRIL 2003, 340-345. Reported a method of converting methanol to hydrogen in cold plasma. The feature is that: under different reaction condition, methanol is converted by using a ferroelectric packed-bed reactor and a silent discharge plasma reactor. Hydrogen yield decreases in the order: ferroelectric packed-bed reactor>silent discharge plasma reactor. And ethylene glycol is not mentioned in the product in the Journal

Literature: Chinese Chemical Letters. VOL. 14, No. 6, 2003, 631-633. Reported a method of converting methanol to hydrogen in corona discharge plasma. The feature is that: the water content in methanol solution has a significant impact on reaction when converting methanol to hydrogen in corona discharge at room temperature. The conversion of methanol increases from 0.196 to 0.284 mol/h along with the water content from 1.0% to 16.7%. In the Journal, it said that as by-product, the yield of ethylene glycol also increases from 0.0045 to 0.0075 mol/h along with water content increasing.

Literature: Chemistry Letters. VOL. 33, No. 6, 2004, 744-745. Reported a method of converting methanol to hydrogen in corona discharge plasma. The feature is that: methanolysis in DC and AC corona discharge to prepare hydrogen. Hydrogen production rate can be higher when in AC corona discharge and the energy consumption is below 0.02 Wh/Ncm₃H₂. Ethylene glycol is not mentioned in the product in the Journal.

Literature: JSME International Journal, Series B, VOL. 48, No. 3, 2005, 432-439. Reported a method of converting methanol in cold plasma. The feature is that: in air atmosphere, methanolysis in cold plasma that is generated in DBD reactor. OH is an important free radical in methanolysis. Ethylene glycol is not mentioned in the product in the Journal.

Literature: INTERNATIONAL JOURNAL OF HYDROGEN ENERGY, 34 (2009), 48-55. Reported a method of methanol solution electrolysis in glow discharge. The feature is that: when electrolyzing methanol solution in cathodal and zincous glow discharge separately, it found that, as the main product, the yield of hydrogen and methyl aldehyde increases with the concentration of methanol solution increasing. Ethylene glycol is not mentioned in the product in the Journal.

Literature: J. Phys. Chem. A, VOL. 114, No. 11, 2010, 4009-4016. Reported a method of converting methanol in plasma. The feature is that: compared to the structure of two different plasma reactors as methanolysis in Dielectric Barrier Discharge in air atmosphere. In the Journal, it investigates the impact of the surface roughness of electrode and the electrode filled with different electrolyte, like Al₂O₃ or BaTiO₃, on the conversion of methanol. The main product in discharge are hydrogen and carbon monoxide without hydrocarbon of a long chain and coke.

In the literature and patent about plasma discharge, methanol conversion aims at hydrogen production. The yield and selectivity of methyl ether, ethanol, ethylene glycol are very low. For now, there is no report about methanol to ethylene glycol in plasma.

Now oxirane non-catalytic hydration is the main method of ethylene glycol production and also the only industrialized method. It's mature and large-tonnage. But it has a long technological process with many disadvantages like: a lot of devices, high energy consumption, and serious pollution. All that increase the cost of ethylene glycol. At the same time, some other new methods of ethylene glycol synthesis have a lot of problem and they are all hardly industrialized. Different from thermocatalytic and photocatalytic technology, the feature of plasma is that: activating the reactant by using the high-energy electron in discharge to produce free radical. Without catalyst, the free radical was reacted to synthesis product in chain propagation. It's non-pollution

Plasma described as material of the fourth state. When high temperature or extra high voltage applied to the neutral substance, it produces atom, electron, positive ions, negative ions, free radical, UV-light, visible light and so on in motivative, dissociative, and ionized reaction. The system, which consists of positive particle and neutral particle, is called plasma because the positive and negative charges are equal macroscopically.

Under the accelerated action of applied electric field, the electrons in plasma accumulate kinetic energy. The electrons with high energy collide inelastic with the reactant molecule, which leads to the dissociation and excitation of the reactant molecule. With high chemical reactivity, the ions, the molecules or atoms in excited state, and the free radicals in plasma can react with each other in collision. According to the energy state, gas temperature and particle density, plasma can be divided into high-temperature plasma, thermal plasma and cold plasma.

Cold plasma is in thermodynamics unbalanced state. Electron temperature (Tₑ)>>ion temperature (Tᵢ)>>neutral particle temperature (Tₙ). It is the most widely used in industrial production because of its high electron-energy and low gas-temperature. In one side, the electrons energy is high enough to the excitation, dissociation and ionization of reactant molecule. In the other side, the reaction system should hold low-temperature to reduce the energy consumption so that the reaction can be easily controlled. The main producing way of cold plasma is that: corona discharge, glow discharge, spark discharge, dielectric barrier discharge, sliding arc discharge, microwave plasma, RF plasma and so on.

In all kinds of method about plasma production, the exist of molecules, atoms, ions and electrons will be different from the pressure, field intensity, current, discharge frequency and the structure of the discharge device.

As it's with different numbers of the molecules, atoms, molecules and atoms in excited state, electrons, ions and free radical in different plasma state and it has different energy, we can adjust the electron energy and the amount of active species with suitable structure of reactor, discharge modes and discharge condition. Specific active state of reactant corresponds to specific reaction and reaction product. The other technologies of methanol conversion are to obtain H₂, methane, methanol, methyl aldehyde, ethane, propane, CO, CO₂ or H₂O. In this invention, it is to obtain ethylene glycol, ethanol, n-propanol and other alcohols because it has different electron energy in discharge to produce different active species.

The characteristic of methanol conversion in plasma can be described as: when applying high voltage to the methanol molecule inside the reactor, the electrons get higher momentum and collide with the methanol molecules surrounding. So the methanol molecules ionize to generate more and more electrons, which leads to electron avalanche. And then methanol molecules turn into excited state as the electrons collide inelastic with them to deliver the energy. If the energy is over the bond energy of the specific chemical bond in methanol molecule, the bond will break or rearrange to generate the free radicals of .CH₂OH, .CH₃, CH₃O., H., OH., ¹CH₂ and species of H₂O, trans-HCOH, cri-HCOH, CH₂O. The active species collide more with each other and react to generate HOCH₂CH₂OH, C₂H₆, CH₃OCH₃, H₂ and so on. If the active species collide more with the high-energy electrons and deliver energy, the chemical bond can break more to generate the free radical of CH₂., CH., C., HCO., CO, which can react more to generate CH₃CH₂OH, CH₃CH₂CH₂OH, CH₃CH₂CH₃, C₂H₂, C₂H₄, C₃H₆, even H₂ and C.

Obviously, we can trigger specific reaction by changing the electron energy in plasma discharge to activate the specific chemical bond in methanol molecule selectively. Such as: in the methanol molecule, the energy of bond C—H, C—O and O—H are respective 94.57 kcal·mol⁻¹, 81.51 kcal·mol⁻¹ and 104.9 kcal·mol⁻¹. The free electron e would collide inelastic with methanol molecule in plasma when accelerated in electric field to get high kinetic energy. When the energy from e to methanol molecule is just 94.57 kcal·mol⁻¹, the methanol molecule dissociates to .CH₂OH. The two .CH₂OH can generate HOCH₂CH₂OH. In the same way, When the energy from e to methanol molecule is just 81.51 kcal·mol⁻¹, the methanol molecule dissociates to .CH₃ and OH.. When the energy from e to methanol molecule is just 104.9 kcal·mol⁻¹, the methanol molecule dissociates to CH₃O. and H.. The two dissociations lead to secondary reaction. So it is important to control the electron energy, or average electron energy, to be appropriate for the activation of bond C—H in methanol molecule.

### Invention Content:

The invention provides a method of converting methanol to ethylene glycol one step in non-equilibrium plasma. When discharging, the high energy electron in plasma collides with the methanol molecule to produce .CH₂OH. And two .CH₂OH can couple to ethylene glycol.

The invention aims at generating ethylene glycol selectively by adjusting the electron energy in plasma. The technology proposal is following:

a. Optimization by different discharge modes. The discharge modes are that: corona discharge, glow discharge and dielectric barrier discharge.

b. Optimization by different structures of reactor. The reactors are that: wire-cylinder reactor, board-board reactor, needle-board reactor and tube-board reactor.

c. Optimization by different parameters of reactor. The parameters are that: the length of discharge zone, electrode spacing, dielectric, high voltage, the material of earth electrode.

d. Optimization by discharge condition. The conditions are that: discharge voltage, discharge frequency, discharge atmosphere, methanol/carrier-gas mole ratio, discharge pressure, discharge temperature;

The technology proposal in the invention is characterized in that:
(1) one of the discharge technologies is used to activate methanol molecule:

\textcircled{1} dielectric barrier discharge: Board-board reactor, tube-board reactor, needle-board reactor and wire-cylinder reactor were used and the dielectric can be monolayer or double layers which can be covered around electrode or placed between the two electrodes.

The high voltage electrode of wire-cylinder reactor is a metal wire placed along the axis of cylinder, and the ground electrode is a metal board (net or wire) which surrounding the cylinder. The two-electrode distance is defined as the distance between the metal wire placed along the axis and the inner face of cylinder ground electrode, and which was designed from 0.30 to 20 mm. There are two kinds of wire-cylinder reactor, the one use the cylinder reactor as the only dielectric, the other including two dielectrics and the second dielectric is inserted between the two electrodes, except the cylinder reactor as the first dielectric. An inlet of methanol and carrier gas is designed at the top of cylinder reactor.

Needle-board reactor is comprised of a flat metal board and a metal board which is equipped with a range of metal needles. Two metal boards are fixed in the reactor at horizon direction, and the electrode distance is defined as the vertical distance between the bottom of metal needle and flat metal board. The dielectric is placed between the two electrodes and the distance to the two electrodes can be adjusted with freedom. The inlet of raw materials and outlet of products are also designed in the cylinder of reactor, respectively.

Tube-board reactor is comprised of a metal tube and a flat metal board. The metal board is fixed in the reactor at horizon direction, the metal tube is vertically placed at the center of flat metal board; and the electrode distance is defined as the vertical distance between the bottom of metal tube and flat metal board. The dielectric is placed between the two electrodes and the distance to the two electrodes can be adjusted with freedom. Methanol and carrier gas is introduced from metal tube or the inlet designed at the top of cylinder reactor, and the outlet of products is designed at the bottom of cylinder reactor.

Board-board reactor is comprised of two flat metal boards which are parallel fixed in the reactor at horizon direction, and the electrode distance is defined as the vertical distance between the two flat metal boards. The dielectric is placed between the two electrodes and the distance to the two electrodes can be adjusted with freedom. Dielectric can be single layer or multiple layers. The inlet of raw materials and outlet of products are also designed in the cylinder of reactor, respectively.

The electrodes distance of the three reactors mentioned above is from 0.2 to 40 mm. Optimized range is from 2 to 10 mm;

The shell material of four reactors mentioned above is insulating, like hard glass, alumina ceramics, Teflon or metal and nonmetal composite designed for insulation of high voltage. The shape and size of reactor shell can be designed practically. The scale-up of reactor can be true through the scale-up of single reactor or reactors in parallel.

The dielectric mentioned above is made up of insulating material. The insulating material has smoother surface, heat resistance, high mechanical strength and it's non-reactive with the feed and the product. Quartz glass, hard glass, mica and Al₂O₃ ceramics are optimized. The total thickness of dielectric is from 0.3 to 10 mm and optimized range is 0.5 to 3.0 mm.

The electrodes of the reactor mentioned above are made up of metal material. The metal material has smoother surface, heat resistance and high mechanical strength. It can be Cu, Fe, W, stainless steel, Pt, Pd and stainless steel with Ti or Ni. Of which, Cu, Fe, W and stainless steel are the optimized.

The diameter of metal tube mentioned above is from 0.5 to 12 mm and optimized range is from 2 to 8 mm. The diameter ratio of metal board to metal tube is from 1 to 20.

The AC high voltage power is used to generate sinusoid waveform output voltage at the frequency from 1 to 50 kHz in the dielectric barrier discharge and optimized range is from 5 to 20 kHz.

\textcircled{2} Corona discharge: A reactor with needle-board configuration is used in corona discharge. The reactor is comprised of a metal needle and a flat metal board, both of them can be used as high voltage electrode or ground electrode. The power is a high voltage DC power supply. The electrodes distance is from 0.5 to 18 mm and optimized range is from 2 to 10 mm. The electrode distance is defined as the vertical distance between the bottom of metal needle and flat metal board.

The electrodes mentioned above are made up of metal material. The metal material has smoother surface, heat resistance and high mechanical strength. It can be Cu, Fe, W, Al, stainless steel and Ni. Of which, Al, Fe, W and Ni are optimized.

\textcircled{3} Pulse corona discharge: A reactor with wire-cylinder configuration is used in pulse corona discharge. The one electrode is a metal cylinder, and the other electrode is a metal wire placed along the axis of metal cylinder. The two-electrode distance is defined as the distance between the metal wire and the inner face of metal cylinder, and which is designed from 5 to 40 mm. Optimized range is from 15 to 30 mm.

The power is a pulse high voltage DC power supply with a peak voltage from 20 to 60 kV and a frequency from 10 to 150 Hz. Optimized range is that: peak voltage from 38 to 46 kV and frequency from 50 to 100 Hz. The pulse voltage generate from energy-storage capacitor by the way of trapping from spark gap to electric load. The peak voltage and frequency are adjustable.

The electrodes mentioned above are made up of metal material. The metal material has smoother surface, heat resistance and high mechanical strength. It can be Cu, Fe, W, Al, stainless steel, Ni, Pt and Pb. Of which, Fe, stainless steel, Ni and Pt are optimized.

\textcircled{4} Glow discharge: A reactor with wire-cylinder or board-board configuration is used in glow discharge.

Pulse DC and AC are both used. When a pulse DC high voltage power is used: energy capacitance release energy to load by a spark gap, and peak voltage is from 10 to 60 kV and frequency is from 10 to 150 Hz. Optimized range is that: peak voltage from 30 to 50 kV and frequency from 50 to 100 Hz. When a pulse AC high voltage power is used: peak voltage is from 0 to 30 kV and frequency is from 7 to 50 Hz. Optimized range is that: peak voltage from 0 to 10 kV and frequency from 7 to 30 Hz.

The electrodes mentioned above are made up of metal material. The metal material has smoother surface, heat resistance and high mechanical strength. It can be Cu, Fe, W, Al, stainless steel, Ni, Pt and Pb. Of which, Fe, stainless steel, Ni and Pt are optimized. Two-electrode distance is from 1 to 40 mm and optimized range is from 5 to 25 mm. When a wire-cylinder reactor is used: the two-electrode distance is defined as the distance between the center metal wire and the inner face of metal cylinder. When a board-board reactor is used: the two-electrode distance is defined as the vertical distance between the two flat metal boards.

### (2) Convert Activated Methanol to the Target Products:

The temperature of reaction mentioned above is from 25 to 600° C. and optimized range is from 100 to 400° C.

The pressure of reaction is from −0.06 MPa to 0.5 MPa and optimized range is from −0.02 MPa to 0.2 MPa.

The molar ratio of carrier gas-methanol is from 0 to 20 and optimized range is from 0 to 6.

One or two kinds of carrier gas such as N₂, H₂, H₂O, He, Ar, O₂, CO, CO₂, CH₄, C₂H₆ is used. Of which, H₂, H₂O, He, Ar, CH₄ are optimized.

The significance of the invention is that: The starting material methanol is renewable. Methanol can be obtained from coal-syngas or the vaporization of biomass. At the same time, preparing ethylene glycol in plasma is a non-polluting synthetic process in one step without catalyst. It has high selectivity. And the co-product of ethanol and n-propanol can be obtained if the reaction condition is optimized.

### FIGURE LEGENDS

FIG. 1a: DBD—monolayer dielectric wire-cylinder reactor.

FIG. 1b: DBD—double layer dielectric wire-cylinder reactor

FIG. 2: DBD—needle-board reactor

FIG. 3: DBD—tube-board reactor

FIG. 4: DBD—board-board reactor

FIG. 5: Glow Discharge Reactor.

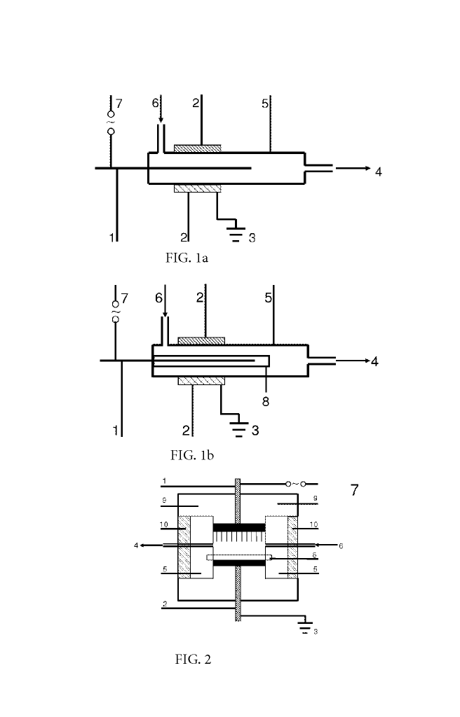

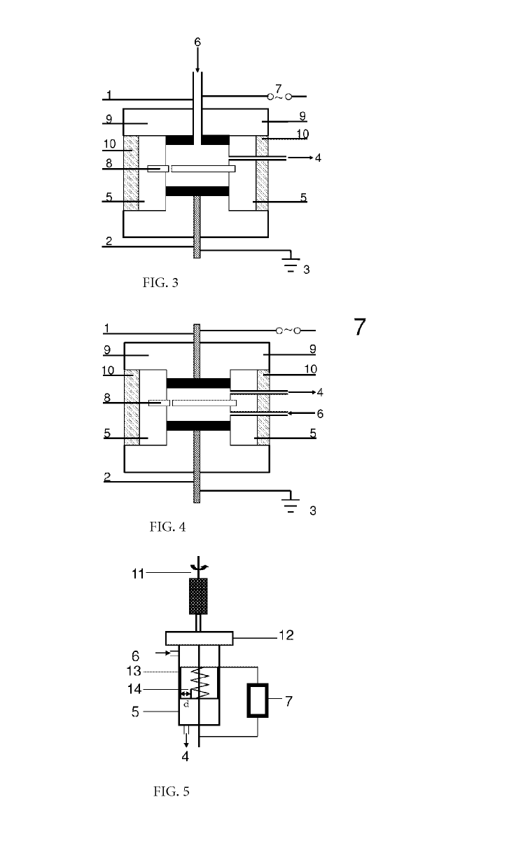

In FIG. 5, 1: high-voltage electrode; 2: earth electrode; 3: earth wire; 4: outlet of gas; 5: reactor shell; 6: inlet of gas; 7: high-voltage source; 8: dielectric barrier; 9: insulating material; 10: heat preservation layer; 11: stirrer spindle; 12: sealing gland for magnetic fluid; 13: cylinder electrode fixed; 14: spiral electrode in rotation.

### APPLICATION EXAMPLES FOR THE INVENTION

The following specific examples are described in detail with technical proposals and figures:

### Comparative Example 1

### SDBD—Wire-Cylinder Reactor

At the pressure of 0.1 MPa, the molar ratio of H₂/methanol is 4:1 (the flow rate H₂ is 20 ml/min, the flow rate of methanol is 5 ml/min), put the gas mixture into the discharge reactor. When the flow is stable, we switch on plasma power to form dielectric barrier discharge. The reactor is wire-cylinder type, the hard glass cylinder with 15 mm outer diameter and 13 mm inner diameter is also used as the dielectric, the center electrode is cooper wire with 1 mm diameter, the earth electrode is cylindrical iron foil with 1 mm thickness which is clings to the outer wall of the glass tube, the electrode distance is 7 mm, the effective discharge length of the reactor is 150 mm.

The parameters of the reactor: the voltage is 5.6 kV, the current is 0.25 A, frequency is 5 kHz, the discharge temperature is 150° C. The reaction result is: methanol conversion is 13%, selectivity of ethylene glycol is 3%, selectivity of ethanol is 1%, selectivity of methane is 60%, selectivity of CO is 29%, selectivity of other hydrocarbons is 7%, and yield of hydrogen is 20%. In this example, because of the large electrode distance, the electron energy in discharge region is too low, the activation degree of methanol is low and the methanol conversion is low. The breakage of C—O is dominant, so methane is the main product.

### Comparative Example 2

### SDBD—Wire-Cylinder Reactor

At the pressure of 0.1 MPa, the molar ratio of He/methanol is 5:1 (the flow rate He is 30 ml/min, the flow rate of methanol is 6 ml/min), put the gas mixture into the discharge reactor. When the flow is stable, we switch on plasma power to form dielectric barrier discharge. The reactor is wire-cylinder type, the hard glass cylinder with 6 mm outer diameter and 4 mm inner diameter is also used as the dielectric, the center electrode is tungsten wire with 3 mm diameter, the earth electrode is cylindrical aluminum foil with 1 mm thickness which is clings to the outer wall of the glass tube, the electrode distance is 1.5 mm, the effective discharge length of the reactor is 130 mm.

The parameters of the reactor: the voltage is 20.0 kV, the current is 0.35 A, frequency is 8 kHz, the discharge temperature is 170° C. The reaction result is: methanol conversion is 73%, selectivity of ethylene glycol is 5%, selectivity of ethanol is 2%, selectivity of n-propyl alcohol is 1%, selectivity of methane is 30%, selectivity of CO is 60%, selectivity of other hydrocarbons is 2%, and yield of hydrogen is 56%. In this example, because of the small electrode distance, the electron energy in discharge region is too high, the methanol conversion is high. The breakage of O—H is dominant, so CO and H₂ are the main products. Because the high-energy electrodes in plasma zone are too many, the chance of collision with methanol molecules is high, so the products are methane, CO and other small molecules products.

### Comparative Example 3

### Corona Discharge

At the pressure of 0.08 MPa, the molar ratio of Ar/methanol is 2:1 (the flow rate Ar is 36 ml/min, the flow rate of methanol is 18 ml/min), put the gas mixture into the discharge reactor. When the flow is stable, we switch on high-voltage power supply to corona discharge. The reactor is needle-board type, the reactor is a quartz tube with 6 mm inner diameter, the two electrodes are fixed at the ends of the reactor, one electrode is stainless steel wire with 2 mm diameter (high-voltage electrode), the other electrode is stainless steel circular plate with 6 mm diameter (earth electrode), the electrode distance is 6 mm.

We use DC positive corona discharge, the discharge voltage is 0.6 kV, the discharge temperature is 400° C. The reaction result is: methanol conversion is 45%, selectivity of ethylene glycol is 0.5%, selectivity of ethanol is 3%, selectivity of methane is 30%, selectivity of CO is 60.5%, selectivity of other hydrocarbons is 6%, and yield of hydrogen is 54%. In this example, because the pressure is low, reactant molecules in unite volume is less, the electrodes in discharge zone can fully collide with reactant molecules and transfer energy, lead to the reactants gain too much energy, so the methanol conversion is high. The breakage of O—H is dominant, so CO and H₂ are the main products. Because the high-energy electrodes in plasma zone are too many, the chance of collision with methanol molecules is high, so the products are methane, CO and other small molecules products.

### Example 1

### SDBD—Wire-Cylinder Reactor

At the pressure of 0.1 MPa, the molar ratio of He/methanol is 2.5:1 (the flow rate He is 25 ml/min, the flow rate of methanol is 10 ml/min), put the gas mixture into the discharge reactor. When the flow is stable, we switch on plasma power to form dielectric barrier discharge. The reactor is wire-cylinder type, the hard glass cylinder with 11 mm outer diameter and 9 mm inner diameter is also used as the dielectric, the center electrode is stainless steel wire with 2 mm diameter, the earth electrode is cylindrical aluminum foil with 1 mm thickness which is clings to the outer wall of the glass tube, the electrode distance is 4.5 mm, the effective discharge length of the reactor is 160 mm.

The discharge parameters of the reactor are that: Voltage: 18.0 kV. Current: 0.28 A. Discharge temperature: 100° C. The discharge frequency remains 10 kHz and discharge power remains 25 W. When the material of the reactor shell changes, the reaction result is that:

Quartz glass: Percent conversion of methanol: 20.49%. Selectivity of ethylene glycol: 38.41%. Selectivity of ethanol: 8.45%. Selectivity of n-propanol: 1.68%.

Hard glass: Percent conversion of methanol: 26.9%. Selectivity of ethylene glycol: 31.25%. Selectivity of ethanol: 7.15%. Selectivity of n-propanol: 1.17%.

Teflon: Percent conversion of methanol: 10.64%. Selectivity of ethylene glycol: 45.70%. Selectivity of ethanol: 6.72%. Selectivity of n-propanol: 1.24%.

Al₂O₃ ceramics: Percent conversion of methanol: 33.26%. Selectivity of ethylene glycol: 29.61%. Selectivity of ethanol: 5.28%. Selectivity of n-propanol: 0.98%.

### Example 2

### DBD—Wire-Cylinder Reactor

Repeat example 1. Double dielectric barrier discharge reactor is used. The material of shell and inner sleeve are both hard glasses. The inner dielectric barrier tube is with thickness of 0.8 mm. The reaction result is that: Percent conversion of methanol is 18.09%. Selectivity of ethylene glycol is 44.39%. Selectivity of ethanol is 7.46%. Selectivity of n-propanol is 1.44%.

### Example 3

### DBD—Wire-Cylinder Reactor

Repeat example 2. When the total thickness' of dielectric barrier changes, the reaction result is that:

Thickness of 1.5 mm: Percent conversion of methanol: 23.25%. Selectivity of ethylene glycol: 17.36%. Selectivity of ethanol: 4.35%. Selectivity of n-propanol: 0.64%.

Thickness of 2.0 mm: Percent conversion of methanol: 16.34%. Selectivity of ethylene glycol: 27.54%. Selectivity of ethanol: 5.36%. Selectivity of n-propanol: 0.83%.

Thickness of 2.5 mm: Percent conversion of methanol: 12.56%. Selectivity of ethylene glycol: 32.18%. Selectivity of ethanol: 6.65%. Selectivity of n-propanol: 1.05%.

Thickness of 3.0 mm: Percent conversion of methanol: 6.36%. Selectivity of ethylene glycol: 47.34%. Selectivity of ethanol: 7.15%. Selectivity of n-propanol: 1.77%.

### Example 4

### DBD—Wire-Cylinder Reactor

Repeat example 2. When the material of earth electrode changes, the reaction result is that:

Bronze network: Percent conversion of methanol: 18.93%. Selectivity of ethylene glycol: 39.54%. Selectivity of ethanol: 3.14%. Selectivity of n-propanol: 0.98%.

Copper wire: Percent conversion of methanol: 13.65%. Selectivity of ethylene glycol: 42.38%. Selectivity of ethanol: 3.68%. Selectivity of n-propanol: 1.03%.

Steel network: Percent conversion of methanol: 9.83%. Selectivity of ethylene glycol: 52.53%. Selectivity of ethanol: 6.34%. Selectivity of n-propanol: 1.56%.

Iron wire: Percent conversion of methanol: 12.39%. Selectivity of ethylene glycol: 47.45%. Selectivity of ethanol: 4.39%. Selectivity of n-propanol: 1.16%.

### Example 5

### DBD—Wire-Cylinder Reactor

Repeat example 2. When the length of earth remains and the length of discharge changes, the reaction result is that:

The length of 5 mm: Percent conversion of methanol: 3.28%. Selectivity of ethylene glycol: 57.42%. Selectivity of ethanol: 8.45%. Selectivity of n-propanol: 1.98%.

The length of 30 mm: Percent conversion of methanol: 7.36%. Selectivity of ethylene glycol: 51.45%. Selectivity of ethanol: 7.24%. Selectivity of n-propanol: 1.54%.

The length of 100 mm: Percent conversion of methanol: 11.49%. Selectivity of ethylene glycol: 46.25%. Selectivity of ethanol: 6.13%. Selectivity of n-propanol: 1.26%.

The length of 300 mm: Percent conversion of methanol: 19.53%. Selectivity of ethylene glycol: 39.43%. Selectivity of ethanol: 5.34%. Selectivity of n-propanol: 1.01%.

The length of 400 mm: Percent conversion of methanol: 25.36%. Selectivity of ethylene glycol: 32.26%. Selectivity of ethanol: 4.17%. Selectivity of n-propanol: 0.93%.

### Example 6

### DBD—Needle-Board Reactor

At the pressure of 0.12 MPa, the molar ratio of Ar/methanol is 5:1 (the flow rate Ar is 35 ml/min, the flow rate of methanol is 7 ml/min), put the gas mixture into the discharge reactor. When the flow is stable, we switch on plasma power to form dielectric barrier discharge. The needle-board reactor is made of hard glass with 12 mm outer diameter and 1 mm thickness, the material of the high-voltage electrode and the earth electrode are both stainless steel. The earth electrode is metal plate with 10 mm diameter and 0.2 mm thickness, the high-voltage electrode is metal bar with 1.2 mm diameter, the dielectric is mica plate, the electrode distance is 6 mm.

The discharge parameters of the reactor are that: Voltage: 17.0 kV. Current: 0.32 A. Discharge frequency: 7 kHz. Discharge temperature: 80° C. The discharge frequency remains 7 kHz and discharge power remains 18 W. When the dielectric barrier thickness changes, the reaction result is that:

The thickness of 0.5 mm: Percent conversion of methanol: 26.38%. Selectivity of ethylene glycol: 37.26%. Selectivity of ethanol: 6.45%. Selectivity of n-propanol: 1.67%.

The thickness of 1.0 mm: Percent conversion of methanol: 18.12%. Selectivity of ethylene glycol: 41.37%. Selectivity of ethanol: 5.21%. Selectivity of n-propanol: 1.34%.

The thickness of 1.5 mm: Percent conversion of methanol: 11.35%. Selectivity of ethylene glycol: 49.65%. Selectivity of ethanol: 4.37%. Selectivity of n-propanol: 1.16%.

The thickness of 2.0 mm: Percent conversion of methanol: 7.73%. Selectivity of ethylene glycol: 53.84%. Selectivity of ethanol: 3.25%. Selectivity of n-propanol: 0.94%.

The thickness of 3.0 mm: Percent conversion of methanol: 3.62%. Selectivity of ethylene glycol: 61.27%. Selectivity of ethanol: 1.12%. Selectivity of n-propanol: 0.72%.

### Example 7

### DBD—Needle-Board Reactor

Repeat example 6. The thickness of dielectric barrier remains 1.0 mm. When the material of dielectric barrier changes, the reaction result is that:

Quartz glass: Percent conversion of methanol: 21.56%. Selectivity of ethylene glycol: 38.24%. Selectivity of ethanol: 3.46%. Selectivity of n-propanol: 1.17%.

Al₂O₃ ceramics: Percent conversion of methanol: 15.27%. Selectivity of ethylene glycol: 49.86%. Selectivity of ethanol: 5.37%. Selectivity of n-propanol: 1.52%.

Hard glass: Percent conversion of methanol: 9.35%. Selectivity of ethylene glycol: 58.35%. Selectivity of ethanol: 6.26%. Selectivity of n-propanol: 2.66%.

### Example 8

### DBD—Needle-Board Reactor

Repeat example 6. The thickness of dielectric barrier remains 1.0 mm. When the electrodes distance changes, the reaction result is that:

The distance of 2.0 mm: Percent conversion of methanol: 42.27%. Selectivity of ethylene glycol: 23.35%. Selectivity of ethanol: 9.35%. Selectivity of n-propanol: 1.74%.

The distance of 3.0 mm: Percent conversion of methanol: 31.58%. Selectivity of ethylene glycol: 39.52%. Selectivity of ethanol: 7.25%. Selectivity of n-propanol: 1.26%.

The distance of 4.0 mm: Percent conversion of methanol: 21.75%. Selectivity of ethylene glycol: 41.64%. Selectivity of ethanol: 5.42%. Selectivity of n-propanol: 1.04%.

The distance of 5.0 mm: Percent conversion of methanol: 13.52%. Selectivity of ethylene glycol: 55.56%. Selectivity of ethanol: 4.36%. Selectivity of n-propanol: 0.88%.

### Example 9

### DBD—Needle-Board Reactor

Repeat example 6. The thickness of dielectric barrier remains 1.0 mm. When the material of electrodes changes, the reaction result is that:

Brass: Percent conversion of methanol: 17.35%. Selectivity of ethylene glycol: 37.82%. Selectivity of ethanol: 6.25%. Selectivity of n-propanol: 1.98%.

Aluminum: Percent conversion of methanol: 12.25%. Selectivity of ethylene glycol: 42.37%. Selectivity of ethanol: 5.16%. Selectivity of n-propanol: 2.15%.

Cast copper: Percent conversion of methanol: 12.38%. Selectivity of ethylene glycol: 52.78%. Selectivity of ethanol: 6.28%. Selectivity of n-propanol: 0.95%.

Tungsten: Percent conversion of methanol: 21.85%. Selectivity of ethylene glycol: 39.75%. Selectivity of ethanol: 6.42%. Selectivity of n-propanol: 0.82%.

### Example 10

### DBD—Needle-Board Reactor

Repeat example 6. The thickness of dielectric barrier remains 1.0 mm. When the discharge power changes, the reaction result is that:

The power of 7.35 W: Percent conversion of methanol: 5.78%. Selectivity of ethylene glycol: 56.25%. Selectivity of ethanol: 7.32%. Selectivity of n-propanol: 2.24%.

The power of 12.38 W: Percent conversion of methanol: 15.27%. Selectivity of ethylene glycol: 49.78%. Selectivity of ethanol: 6.24%. Selectivity of n-propanol: 1.65%.

The power of 25.76 W: Percent conversion of methanol: 21.36%. Selectivity of ethylene glycol: 38.45%. Selectivity of ethanol: 5.24%. Selectivity of n-propanol: 1.05%.

The power of 39.83 W: Percent conversion of methanol: 39.79%. Selectivity of ethylene glycol: 29.75%. Selectivity of ethanol: 4.13%. Selectivity of n-propanol: 0.94%.

The power of 51.28 W: Percent conversion of methanol: 62.74%. Selectivity of ethylene glycol: 17.28%. Selectivity of ethanol: 3.58%. Selectivity of n-propanol: 0.76%.

### Example 11

### DBD—Needle-Board Reactor

Repeat example 6. The thickness of dielectric barrier remains 1.0 mm. When the discharge frequency changes, the reaction result is that:

The frequency of 6.0 kHz: Percent conversion of methanol: 29.35%. Selectivity of ethylene glycol: 26.28%. Selectivity of ethanol: 3.59%. Selectivity of n-propanol: 1.01%.

The frequency of 12.0 kHz: Percent conversion of methanol: 18.72%. Selectivity of ethylene glycol: 38.27%. Selectivity of ethanol: 5.28%. Selectivity of n-propanol: 1.82%.

The frequency of 18.0 kHz: Percent conversion of methanol: 13.27%. Selectivity of ethylene glycol: 46.37%. Selectivity of ethanol: 6.24%. Selectivity of n-propanol: 2.15%.

The frequency of 24.0 kHz: Percent conversion of methanol: 24.27%. Selectivity of ethylene glycol: 33.28%. Selectivity of ethanol: 4.37%. Selectivity of n-propanol: 1.34%.

The frequency of 30.0 kHz: Percent conversion of methanol: 8.76%. Selectivity of ethylene glycol: 59.79%. Selectivity of ethanol: 7.35%. Selectivity of n-propanol: 2.53%.

### Example 12

### DBD—Needle-Board Reactor

Repeat example 6. The thickness of dielectric barrier remains 1.0 mm. When the carrier gas changes, the reaction result is that:

Oxygen: Percent conversion of methanol: 23.15%. Selectivity of ethylene glycol: 24.76%. Selectivity of ethanol: 4.82%. Selectivity of n-propanol: 1.28%.

Nitrogen: Percent conversion of methanol: 17.28%. Selectivity of ethylene glycol: 31.85%. Selectivity of ethanol: 4.93%. Selectivity of n-propanol: 1.62%.

Methane: Percent conversion of methanol: 8.35%. Selectivity of ethylene glycol: 56.75%. Selectivity of ethanol: 7.25%. Selectivity of n-propanol: 2.73%.

Argon: Percent conversion of methanol: 16.27%. Selectivity of ethylene glycol: 38.75%. Selectivity of ethanol: 5.27%. Selectivity of n-propanol: 1.72%.

Helium: Percent conversion of methanol: 10.52%. Selectivity of ethylene glycol: 46.25%. Selectivity of ethanol: 6.31%. Selectivity of n-propanol: 2.14%.

### Example 13

### DBD—Needle-Board Reactor

Repeat example 6. The thickness of dielectric barrier remains 1.0 mm. When the ratio of argon and methanol changes, the reaction result is that:

The ratio is 0: Percent conversion of methanol: 29.52%. Selectivity of ethylene glycol: 15.34%. Selectivity of ethanol: 3.12%. Selectivity of n-propanol: 0.86%.

The ratio is 2: Percent conversion of methanol: 25.37%. Selectivity of ethylene glycol: 25.86%. Selectivity of ethanol: 4.28%. Selectivity of n-propanol: 1.35%.

The ratio is 6: Percent conversion of methanol: 18.75%. Selectivity of ethylene glycol: 34.27%. Selectivity of ethanol: 5.82%. Selectivity of n-propanol: 2.15%.

The ratio is 12: Percent conversion of methanol: 13.24%. Selectivity of ethylene glycol: 48.75%. Selectivity of ethanol: 6.34%. Selectivity of n-propanol: 3.82%.

The ratio is 18: Percent conversion of methanol: 8.28%. Selectivity of ethylene glycol: 59.36%. Selectivity of ethanol: 7.52%. Selectivity of n-propanol: 4.22%.

### Example 14

### DBD—Needle-Board Reactor

Repeat example 6. The thickness of dielectric barrier remains 2.0 mm. When the reaction temperature changes, the reaction result is that:

50° C.: Percent conversion of methanol: 12.37%. Selectivity of ethylene glycol: 57.62%. Selectivity of ethanol: 8.34%. Selectivity of n-propanol: 2.18%.

150° C.: Percent conversion of methanol: 18.25%. Selectivity of ethylene glycol: 45.37%. Selectivity of ethanol: 7.52%. Selectivity of n-propanol: 1.97%.

250° C.: Percent conversion of methanol: 29.37%. Selectivity of ethylene glycol: 35.24%. Selectivity of ethanol: 6.29%. Selectivity of n-propanol: 1.42%.

350° C.: Percent conversion of methanol: 34.56%. Selectivity of ethylene glycol: 26.27%. Selectivity of ethanol: 5.95%. Selectivity of n-propanol: 1.05%.

450° C.: Percent conversion of methanol: 44.31%. Selectivity of ethylene glycol: 15.48%. Selectivity of ethanol: 3.84%. Selectivity of n-propanol: 0.82%.

### Example 15

### DBD—Needle-Board Reactor

Repeat example 6. The thickness of dielectric barrier remains 2.0 mm. The reaction temperature remains 220° C. When the reaction pressure changes, the reaction result is that:

0.02 MPa: Percent conversion of methanol: 28.52%. Selectivity of ethylene glycol: 29.38%. Selectivity of ethanol: 6.17%. Selectivity of n-propanol: 0.76%.

0.06 MPa: Percent conversion of methanol: 21.37%. Selectivity of ethylene glycol: 37.22%. Selectivity of ethanol: 7.23%. Selectivity of n-propanol: 0.98%.

0.10 MPa: Percent conversion of methanol: 13.28%. Selectivity of ethylene glycol: 45.76%. Selectivity of ethanol: 8.32%. Selectivity of n-propanol: 1.37%.

0.16 MPa: Percent conversion of methanol: 10.52%. Selectivity of ethylene glycol: 58.34%. Selectivity of ethanol: 8.94%. Selectivity of n-propanol: 1.56%.

### Example 16

### DBD—Tube-Board Reactor

At the pressure of 0.1 MPa, the molar ratio of He/methanol is 3:1 (the flow rate He is 30 ml/min, the flow rate of methanol is 10 ml/min), put the gas mixture into the discharge reactor. When the flow is stable, we switch on plasma power to form dielectric barrier discharge. The tube-board reactor shell is made up of quartz glass with 13 mm outer diameter and 1.5 mm thickness, the material of metal plate electrode and metal tube electrode are both stainless steel. The metal plate is with 10 mm diameter and 0.3 mm thickness. The electrode distance is 5.0 mm. The dielectric barrier is single layer quartz glass with 1.0 mm thickness.

The discharge parameters of the reactor are that: Voltage: 20.0 kV. Current: 0.42 A. Discharge frequency: 10 kHz. Discharge temperature: 150° C. The discharge frequency remains 10 kHz and discharge power remains 21.5 W. When the diameter of the metal tube changes, the reaction result is that:

Diameter of 2 mm: Percent conversion of methanol: 38.56%. Selectivity of ethylene glycol: 29.38%. Selectivity of ethanol: 3.58%. Selectivity of n-propanol: 0.67%.

Diameter of 3 mm: Percent conversion of methanol: 27.38%. Selectivity of ethylene glycol: 34.27%. Selectivity of ethanol: 7.39%. Selectivity of n-propanol: 0.95%.

Diameter of 5 mm: Percent conversion of methanol: 18.82%. Selectivity of ethylene glycol: 41.35%. Selectivity of ethanol: 10.58%. Selectivity of n-propanol: 1.25%.

Diameter of 6 mm: Percent conversion of methanol: 11.35%. Selectivity of ethylene glycol: 59.27%. Selectivity of ethanol: 12.37%. Selectivity of n-propanol: 1.56%.

The other parameters of the device are the same as that of needle-board reactor. With suitable structure, discharge condition and reaction condition, they all could be used in this invention.

### Example 17

### DBD—Board-Board Reactor

At the pressure of 0.12 MPa, the molar ratio of N₂/methanol is 4:1 (the flow rate N₂ is 24 ml/min, the flow rate of methanol is 6 ml/min), put the gas mixture into the board-board reactor. When the flow is stable, we switch on plasma power to form dielectric barrier discharge. The board-board reactor is with 3.0 mm thickness and 80 mm diameter. The material is stainless steel. The electrode distance is 12 mm. the effective discharge length of the reactor is 120 mm. The material of dielectric barrier is quartz glass with 0.3 mm thickness.

The discharge parameters of the reactor are that: Voltage: 21.0 kV. Current: 0.48 A. Discharge frequency: 13.0 kHz. Discharge temperature: 180° C. The discharge frequency remains 13 kHz and discharge power remains 32 W. When the number of the dielectric barrier layers changes, the reaction result is that:

Single layer: Percent conversion of methanol: 36.68%. Selectivity of ethylene glycol: 18.76%. Selectivity of ethanol: 4.58%. Selectivity of n-propanol: 0.95%.

Two layers: Percent conversion of methanol: 28.18%. Selectivity of ethylene glycol: 25.37%. Selectivity of ethanol: 5.37%. Selectivity of n-propanol: 1.34%.

Three layers: Percent conversion of methanol: 16.82%. Selectivity of ethylene glycol: 37.25%. Selectivity of ethanol: 6.47%. Selectivity of n-propanol: 1.87%.

Four layers: Percent conversion of methanol: 8.31%. Selectivity of ethylene glycol: 46.73%. Selectivity of ethanol: 7.21%. Selectivity of n-propanol: 2.19%.

### Example 18

### Pulse Corona Discharge

At the pressure of 0.10 MPa, the molar ratio of H₂/methanol is 5:1 (the flow rate H₂ is 40 ml/min, the flow rate of methanol is 8 ml/min), put the gas mixture into the discharge reactor. When the flow is stable, we switch on plasma power to form corona discharge. The reactor is wire-cylinder type, the center line is copper electrode placed Pt and the length is 2 mm, cylinder type electrode is stainless steel cylinder and the length and inner diameter is 250 mm and 20 mm, the effective discharge length of reactor is 80 mm.

The power supply is pulsed DC high voltage power supply, the energy capacitance release energy to load by a spark gap to produce pulse voltage. The parameters of the reactor: The peak voltage: 30 kV. Pulse repetition frequency: 78 kHz. The discharge temperature: 180° C. The reaction result is that: methanol conversion: 33.50%. Selectivity of ethylene glycol: 17.38%. Selectivity of ethanol: 6.78%. Selectivity of n-propanol: 1.56%.

### Example 19

### Glow Discharge

At the pressure of 0.12 MPa, the molar ratio of O₂/methanol is 1:1 (the flow rate O₂ is 20 ml/min, the flow rate of methanol is 20 ml/min), put the gas mixture into the discharge reactor. When the flow is stable, we switch on plasma power to form glow discharge. In the reactor, the rotary spiral electrode connects with magnetic fluid sealed device by an insulating connector. And then connect it to the rotating mechanism. When AC high-voltage reaches the gas breakdown voltage, the gases react in the plasma zone between the two electrodes, and the reactants pass through the plasma zone vertically in process of rotating discharge. The reactor is a wire-cylinder type, the central electrode is metal nickel electrode (the diameter is 3 mm), the outer electrode is stainless steel cylinder (outer diameter is 27 mm, inner diameter is 25 mm), the electrode distance is 11 mm, the length of discharge zone is 100 mm.

The discharge parameters of the reactor are that: operating frequency of bipolar high-voltage pulse power supply: 14 kHz. Duty cycle of the pulse power: 9%. Peak voltage: 1.6 kV. The discharge temperature: 350° C. The reaction result is that: methanol conversion: 21.36%. Selectivity of ethylene glycol: 12.57%. Selectivity of ethanol: 6.24%. Selectivity of n-propanol: 2.15%.

We claim:

1. A method of methanol conversion is characterized in that:
(1) one of the discharge technologies is used to activate methanol molecule:
\textcircled{1} dielectric barrier discharge: Board-board reactor, tube-board reactor, needle-board reactor and wire-cylinder reactor were used and the dielectric can be monolayer or double layers which can be covered around electrode or placed between the two electrodes.
The high voltage electrode of wire-cylinder reactor is a metal wire placed along the axis of cylinder, and the ground electrode is a metal board (net or wire) which surrounds the cylinder. The two-electrode distance is defined as the distance between the metal wire placed along the axis and the inner face of cylinder ground electrode, and which was designed from 0.30 to 20 mm. There are two kinds of wire-cylinder reactor, the one use the cylinder reactor as the only dielectric, the other includes two dielectrics and the second dielectric is inserted between the two electrodes, except the cylinder reactor as the first dielectric. An inlet of methanol and carrier gas is designed at the top of cylinder reactor.
Needle-board reactor is comprised of a flat metal board and a metal board which is equipped with a range of metal needles. Two metal boards are fixed in the reactor at horizon direction, and the electrode distance is defined as the vertical distance between the bottom of metal needle and flat metal board. The dielectric is placed between the two electrodes and the distance to the two electrodes can be adjusted with freedom. The inlet of raw materials and outlet of products are also designed in the cylinder of reactor, respectively.
Tube-board reactor is comprised of a metal tube and a flat metal board. The metal board is fixed in the reactor at horizon direction, the metal tube is vertically placed at the center of flat metal board; and the electrode distance is defined as the vertical distance between the bottom of metal tube and flat metal board. The dielectric is placed between the two electrodes and the distance to the two electrodes can be adjusted with freedom. Methanol and carrier gas is introduced from metal tube or the inlet designed at the top of cylinder reactor, and the outlet of products is designed at the bottom of cylinder reactor.
Board-board reactor is comprised of two flat metal boards which are parallel fixed in the reactor at horizon direction, and the electrode distance is defined as the vertical distance between the two flat metal boards. The dielectric is placed between the two electrodes and the distance to the two electrodes can be adjusted with freedom. Dielectric can be single layer or multiple layers. The inlet of raw materials and outlet of products are also designed in the cylinder of reactor, respectively.
The electrodes distance of the three reactors mentioned above is from 0.2 to 40 mm, and the thickness of dielectric is from 0.3 to 10 mm;
The diameter of metal tube mentioned above is from 0.5 to 12 mm, and the diameter ratio of metal board to metal tube is from 1 to 20;
The AC high voltage power is used to generate sinusoid waveform output voltage at the frequency from 1 to 50 kHz in the dielectric barrier discharge.
\textcircled{2} Corona discharge: A reactor with needle-board configuration is used in corona discharge. The reactor is comprised of a metal needle and a flat metal board, both of them can be used as high voltage electrode or ground electrode. The power is a high voltage DC power supply. The electrodes distance is from 0.5 to 18 mm, and the electrode distance is defined as the vertical distance between the bottom of metal needle and flat metal board.
\textcircled{3} Pulse corona discharge: A reactor with wire-cylinder configuration is used in pulse corona discharge. One electrode is a metal cylinder, and the other electrode is a metal wire placed along the axis of metal cylinder. The two-electrode distance is defined as the distance between the metal wire and the inner face of metal cylinder, and which was designed from 5 to 40 mm. The power is a pulse high voltage DC power supply with a peak voltage from 20 to 60 kV and a frequency from 10 to 150 Hz.
\textcircled{4} Glow discharge: A reactor with wire-cylinder or board-board configuration is used in glow discharge. When a pulse DC high voltage power is used: energy capacitance release energy to load by a spark gap, and peak voltage is from 10 to 60 kV and frequency is from 10 to 150 Hz; when a pulse AC high voltage power is used: peak voltage is from 0 to 30 kV and frequency is from 7 to 50 Hz.
Two-electrode distance is from 1 to 40 mm; when a wire-cylinder reactor is used: the two-electrode distance is defined as the distance between the center metal wire and the inner face of metal cylinder; when a board-board reactor is used: the two-electrode distance is defined as the vertical distance between the two flat metal boards.
(2) Convert activated methanol to the polyol and higher carbon alcohol, such as ethylene glycol(EG), ethanol, n-propanol, etc.:
The temperature of reaction mentioned above is from 25 to 600° C.; The pressure of reaction is from −0.06 MPa to 0.5 MPa; One or two kinds of carrier gas such as N₂, H₂, H₂O, He, Ar, O₂, CO, CO₂, CH₄, C₂H₆ is used.

2. According to claim 1, the method of methanol conversion is characterized in that: the temperature of discharge reaction is from 100 to 400° C.

3. According to claim 1, the method of methanol conversion is characterized in that: the pressure of discharge reaction is from −0.02 MPa to 0.2 MPa.

4. According to claim 1, the method of methanol conversion is characterized in that: the mole ratio of carrier gas to methanol is from 0 to 6.

5. According to claim 1, the method of methanol conversion is characterized in that: the carrier gas is H₂, H₂O, He, Ar, CH₄ or mixture of them.
